(19) United States
(12) Patent Application Publication
(10) Pub. No.: US 2003/0009007 A1
(43) Pub. Date: Jan. 9, 2003

(54) Process for splitting polyurethanes

(75) Inventor: Klaus Pinske, Haltern (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: DEGUSSA AG, Duesseldorf (DE)

(21) Appl. No.: 10/179,224

(22) Filed: Jun. 26, 2002

(30) Foreign Application Priority Data
Jun. 26, 2001 (DE) 101 30 820.5

(51) Int. Cl. C08G 2/00; C08J 3/00

(52) U.S. Cl. 528/480

(57) ABSTRACT

Polyurethane materials are recycled by a process that includes heating the polyurethane as a mixture with water and a solvent. The polyurethane is decomposed to yield a mixture that contains from 10-90% by weight of water and from 90-10% of solvent. The mixture is heated to above 180° C. to effect the decomposition reaction. The water/solvent mixtures are separated by distillation. The pressure of the reaction is at least 4 bar and the mole ratio of water to urethane bonds is at least 1.

### BACKGROUND OF THE INVENTION

1. Field of the Invention

The present invention relates to a process for splitting and recycling polyurethane materials.

2. Discussion of the Background

With the growth of the polyurethane production industry and polyurethane's widespread use in many applications, waste disposal has become a problem. For ecological, economical and political reasons reuse and recycling of polyurethane materials is a primary goal of the industry.

Numerous examples of processes for recycling polyurethane materials are described in the literature and are carried out both on a laboratory scale and in commercial production plants. These recycling processes typically involve reactions in which the urethane bonds are split.

The most frequently used process is glycolysis, wherein polyurethane is split into a shorter-chain urethane with glycol or a glycol mixture, preferably with ethylene, diethylene, or propylene glycol, as in EP 0 835 901 A2, EP 0 546 415 B1, EP 0 899 292 A1, EP 0 546 415 A1, DE 4 442 379 A1, EP 0 771 644 A2:

—[—R—NH—(C═O)—O—R¹—(OR²)ₘ—O]ₙ—+nHO—R³—OH→nR—NH—(C═O)—O—R³—OH+nHO—R¹—(OR²)ₘ—OH

R (cyclo)aliphatic, aromatic hydrocarbon

R¹, R², R³ alkene

The resulting reaction mixture containing shorter-chain urethanes, which are reactive due to the presence of free hydroxyl groups and the eliminated polyol component, is then polyurethanized with an isocyanate component, generally without further processing. This results in mixed polyurethanes which are used for new, generally less critical, applications. The resulting product's chemical and physical properties are degraded with each reaction cycle and thereby limit the product's suitability for some applications.

Glycolitic splitting is utilized whenever the individual constituents of the recycled polyurethane are not intended to be recovered.

Another process for splitting polyurethanes, which takes greater material recovery into account, is hydrolysis. Carbon dioxide, amines and alcohol constituents are formed by reaction of polyurethane with water:

—[—R—NH—(C═O)—O—R¹—(OR²)ₘ—O]ₙ—+nH₂O→nR—NH₂+nCO₂+nHO—R¹—(OR²)ₘ—OH

R (cyclo)aliphatic, aromatic hydrocarbon

R¹, R² alkene

The advantage of this process is that the amine and the alcohol components can be returned to the amine→isocyanate→polyurethane production cycle and thus the same isocyanate or a homogeneous polyurethane can again be manufactured:

nR—NH₂ [symbol] nR—NCO+nHO—R¹—(OR²)ₘ—OH [symbol] —[—R—NH—(C═O)—O—R¹—(OR²)ₘ—O—]ₙ—

Alternatively, especially in the case of high-value amines and alcohols, these substances can be transferred out of the cycle and used for other chemical reactions.

Hydrolysis of polyurethanes is known from the literature (U.S. Pat. Nos. 4,035,314, 4,316,992, 3,441,616). These processes suffer from a range of technical and economic disadvantages. For example, the rate of hydrolysis is generally low, with long reaction times being required for efficient conversion. With reaction temperatures of greater than 180° C. generally required, undesired secondary reactions can occur to yield non-splittable products. This problem is aggravated in the presence of catalysts.

The availability of superheated water vapor or equipment for its manufacture is a further disadvantage of the above-described hydrolysis processes. With longer reaction times the reaction mixture can become diluted with condensed water which requires continuous, often costly, separation from the reaction batch. Solvents and reactants such as glycol are withdrawn with the water vapor and must be continuously replenished.

Due to the formation of secondary products isolating the splitting products requires considerable technical and apparatus expense.

The aim of the invention was to discover a process for splitting polyurethanes, which is characterized by methods which are both technically simple to carry out and low in secondary products, and which does not present the above-described disadvantages.

### SUMMARY OF THE INVENTION

Accordingly, an object of the invention is a process for splitting polyurethanes, in which the polyurethane materials are reacted at temperatures of at least 180° C. and at a pressure of at least 4 bar, and the mole ratio of water to urethane bonds is at least 1, to form a mixture that is 10-90% by weight of water and 90-10% by weight of one or more solvents.

### DETAILED DESCRIPTION OF THE INVENTION

For this purpose a mixture of polyurethane materials is heated to over 180° C. in a mixture of solvent and water. As a general rule, monovalent or polyvalent aliphatic or cycloaliphatic alcohols, alkyl glycols, dialkyl glycols, dialkyl glycol dialkyl ethers, can be used as solvents, singly or as mixtures thereof. Examples of solvents suitable for the process are methanol, ethanol, propanols, butanols, pentanols, hexanols, ethylene glycol, diethylene glycol, propylene glycol, diethylene glycol dialkyl ether. N-butanol is preferably used as solvent. According to the present invention a mixture of 10-90% by weight of water and 90-10% by weight of solvent is used.

The reaction is performed at a temperature of at least 180° C., preferably between 200 and 230° C. and at a pressure of at least 4 bar, preferably between 4 and 30 bar, particularly preferably between 4 and 10 bar.

If alcohol or glycol is used as a solvent, the reaction pressure decreases with increasing hydrolysis.

A catalyst, preferably sodium hydroxide, accelerates the rate of hydrolysis. In principle, alkali oxide, alkali hydroxide, alkaline earth oxide, alkaline earth hydroxide either singly or in the form of mixtures are suitable as catalysts.

It was found that the reaction equilibrium can be shifted to the amine side of the reaction and that the reaction times can accordingly be shortened if carbon dioxide is removed from the reaction mixture with an inert gas purge, such as nitrogen, helium, argon, or (partially) halogenated hydrocarbons. The formation of secondary products with this method is minimal. Nitrogen is preferably used as the inert gas. The inert gas can be recovered and reused.

When reaction is complete the resulting chemical components are processed and separated by distillation. The water, solvent and amine are fractionated directly from the reaction batch, preferably with vacuum distillation. If a low-boiling polyol component was used in the manufacture of the polyurethane it can also be separated out by distillation and recycled for subsequent polyurethanization. Water and solvent can generally be reused in the splitting reaction without further processing steps. The amine is subject to further purification depending on requirements.

### EXAMPLE

The test polyurethane used for hydrolysis was manufactured from the following constituents. Isophorone diisocyanate (IPDI) was used as an isocyanate component and trimethylolpropane as well as a linear and a branched polypropylene glycol ether (Voranol®, DOW Chem. Comp.) were used an as alcohol component:

| Components | Weight % |
|---|---|
| Voranol CP 450 | 30.88 |
| Voranol P 1010 | 30.88 |
| IPDI/trimethylolpropane adduct | |
| IPDI | 35.73 |
| Trimethylolpropane | 2.36 |
| Other | 0.15 |
| Total | 100.00 |

Hardened, thin plates of the polyurethane were cooled with dry ice, then milled in a mill to a grain size of approx. 3×3×3 mm.

In a 2-liter agitator autoclave, 175 g of the polyurethane were heated with 300 g n-butanol and 50 g of water to 230° C. The internal pressure rose to max. 20.3 bar_{abs}. An intensive nitrogen flow was passed through the reactor via an inlet pipe to continuously strip out the carbon dioxide. After 8 h reaction time the polyurethane had fully dissolved and isophorone diamine had formed quantitatively. The base value of the reaction mixture was 54 mg KOH/g.

First the n-butanol and water, then, after a temperature increase, the isophorone diamine were quantitatively separated out of the reaction batch by vacuum distillation. Polypropylene glycol ether impurities in the amine may be removed by further purification through distillation under vacuum.

German application No. 101 30 820.5, filed on Jun. 26, 2001 is incorporated herein by reference.

Wherever a range appears herein it is intended to include all ranges and subranges between the stated values.

1. A process for splitting one or more polyurethanes, comprising
heating a mixture comprising at least one solvent, water and one or more polyurethanes, to a temperature of at least 180° C. and a pressure of at least 4 bar,
wherein a mole ratio of water to a urethane bond is at least 1, and
wherein said one or more polyurethanes is split into a mixture of water and one or more solvents, said mixture of water and one or more solvents comprising from 10 to 90% by weight of water and from 90 to 10% by weight of said one or more solvents.

2. The process as claimed in claim 1, wherein the solvent is selected from the group consisting of monovalent aliphatic alcohols, polyvalent aliphatic alcohols, monovalent cycloaliphatic alcohols, polyvalent cycloaliphatic alcohols, alkyl glycols, dialkyl glycols, dialkyl glycol dialkyl ethers and mixtures thereof.

3. The process as claimed in claim 2, wherein the solvent is selected from the group consisting of methanol, ethanol, propanol, butanol, pentanol, hexanol, ethylene glycol, diethylene glycol, propylene glycol, diethylene glycol dialkyl ether and mixtures thereof.

4. The process as claimed in claim 1, wherein the solvent is n-butanol.

5. The process as claimed in claim 1, wherein the temperature is from 200 to 230° C.

6. The process as claimed in claim 1, wherein the pressure is from 4 to 30 bar.

7. The process as claimed in claim 1, wherein the pressure is from 4 to 10 bar.

8. The process as claimed in claim 1, further comprising passing an inert gas through the mixture.

9. The process as claimed in claim 8, wherein the inert gas is selected from the group consisting of nitrogen, helium, argon, halogenated hydrocarbons, partially halogenated hydrocarbons and mixtures thereof.

10. The process as claimed in claim 1, wherein the mixture comprising at least one solvent, water and one or more polyurethanes, further comprises a catalyst.

11. The process as claimed in claim 10, wherein the catalyst is selected from the group consisting of alkali oxide, alkali hydroxide, alkaline earth oxide, alkaline earth hydroxide and mixtures thereof.

12. The process as claimed in claim 10, wherein the catalyst is sodium hydroxide.

13. The process as claimed in claim 1, further comprising separating the mixture of water and one or more solvents by distillation.

14. The process as claimed in claim 13, wherein the distillation is a vacuum distillation.

15. The process as claimed in claim 1, further comprising recovering the inert gas.
